(19) United States
(12) Patent Application Publication
(10) Pub. No.: US 2022/0230186 A1
(43) Pub. Date: Jul. 21, 2022

(54) SYSTEM FOR DETERMINING AUTHENTICITY OF SECURITY LABELS

(71) Applicant: Ashish ANAND, Bangalore (IN)

(72) Inventors: Ashish ANAND, Bangalore (IN); Kishor Veerabhadrappa BADIGER, Bangalore (IN); Aman TRIGUNAIT, Bangalore (IN)

(73) Assignee: Ashish ANAND, Bangalore (IN)

(21) Appl. No.: 17/617,319

(22) PCT Filed: Oct. 24, 2019
(86) PCT No.: PCT/IB2019/059097

§ 371 Date: Dec. 8, 2021

(30) Foreign Application Priority Data
Jun. 10, 2019 (IN) 201941022865
Jun. 14, 2019 (IN) 201941023617
Jul. 12, 2019 (IN) 201941028126

(51) Int. Cl. G06Q 30/00

(52) U.S. Cl. CPC G06Q 30/0185

(57) ABSTRACT

The system (100) for determining authenticity of security labels comprises, a security label (102) comprising a crack line (202) and a scanning device (106). The scanning device (106) comprises an image capturing module (302) and a processor module (304). The image capturing module (302) is configured to acquire at least one image of the security label (102) and the processor module (304) is configured to identify position of the crack line (202) using the acquired image, process pixels using the acquired image to determine the count of pixels, wherein the processed pixels are expected to capture the crack line (202) and determine authenticity of the security label (102) based on expected count and actual count of the processed pixels.

### LIST OF PRIORITY DOCUMENTS

The current application claims priority from the following provisional applications filed in India.
201941022865
201941023617
201941028126

### BACKGROUND

### Field of Invention

The disclosed subject matter relates to the field of security labels. More particularly, but not exclusively, the subject matter relates to automated detection of counterfeit security labels.

### Discussion of Prior Art

In logistics, it is a well-known practice to fix security label to the object to be shipped. The security label offers protection against tampering of the object before the object arrives at its destination. However, a person with malicious intent may circumvent the protection offered by the security label by making counterfeits, either photocopy or digital copy, of the security label. Further, the malevolent person may tamper the object and may affix the counterfeit (photocopy) security label onto the object to ensure that the tampering is not detected. In another case, the malevolent person may take digital image of the security label in a digital device like a smart phone and use that image to circumvent the tamper detection process.

One of the conventional methods of detecting a photocopy of a security label is by analysing the printing noise of the security label. The noise on the original security label is registered with a system and further the noise on the security label affixed to the object is determined. If the noise values don't match, then the system may detect the duplication of the security label. However, the drawback with such system is the generation of false positives caused by the dust, dirt or wrinkling of the security label.

Another conventional method of detecting the duplication of security labels is by analysing the micrographics of the security label. The photocopy of the security label loses certain micrographics information during the photocopying process. This loss in micrographics information is used to determine genuineness of the security label. Generally, obtaining micrographics information requires expensive machines with higher DPI (dots per inch). Further, the method does not offer protection against using the digital copy of security label to circumvent the detection process.

In view of the foregoing, it is apparent that there is a need for an improved system and method for detecting duplicate security labels.

### SUMMARY

In an embodiment, a system for determining authenticity of security labels comprises a security label comprising a crack line and a scanning device. The scanning device comprises an image capturing module and a processor module. The image capturing module is configured to acquire at least one image of the security label and the processor module is configured to identify position of the crack line using the acquired image, process pixels using the acquired image to determine the count of pixels, wherein the processed pixels are expected to capture the crack line and determine authenticity of the security label based on expected count and actual count of the processed pixels.

### BRIEF DESCRIPTION OF DRAWINGS

Embodiments are illustrated by way of example and not limitation in the figures of the accompanying drawings, in which like references indicate similar elements and in which:

FIG. 1 illustrates a system 100 for automated detection of duplicate security labels, in accordance with an embodiment.

FIG. 2 illustrates the security label 102, in accordance with an embodiment.

FIG. 3 illustrates the scanning device 106, in accordance with an embodiment.

FIG. 4 is a flowchart 400 of method of determining duplicate security label.

FIGS. 5A-5B is a flowchart 500 of method for detecting digital copy of the security label.

FIG. 6 illustrates a security label 600, in accordance with an embodiment.

FIG. 7 illustrates a security label 700, in accordance with an embodiment.

FIG. 8 is a flow chart 800 of method of authenticating the security label.

FIG. 9 illustrates a security label 900, in accordance with an embodiment.

FIG. 10 illustrates a security label 1000, in accordance with an embodiment.

FIGS. 11A, 11B and 11C illustrates different orientations of the alphanumeric reference, in accordance with an embodiment.

FIG. 12 illustrates a security label 1200, in accordance with an embodiment.

FIGS. 13A, 13B and 13C illustrates the noise created by a non-circular shaped label 1300 upon rotation of the label or scanning device.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

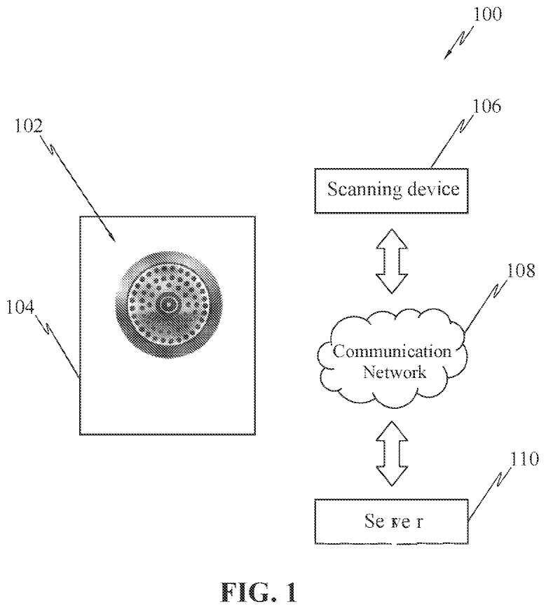

FIG. 1 illustrates a system 100 for automated detection of duplicate security labels, in accordance with an embodiment. The system 100 comprises a security label 102, an article 104, a scanning device 106, a communication network 108 and a server 110. The security label 102 may be affixed to the article 104 that is shipped. The scanning device 106 may be configured to scan the security label 102. Further, the scanning device 106 may be in communication with the server 110 via the communication network 108 to determine the authenticity of the security label 102.

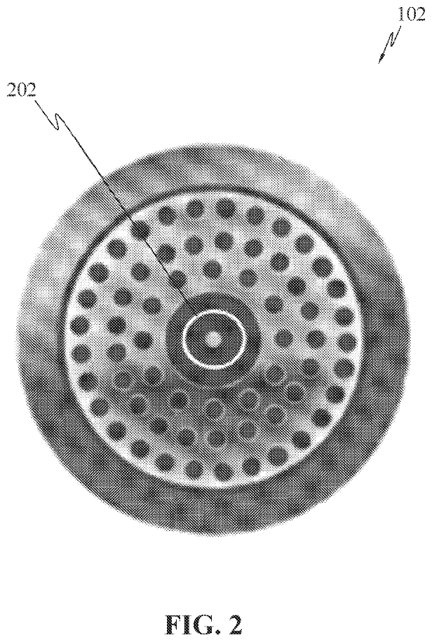

FIG. 2 illustrates the security label 102, in accordance with an embodiment. The security label 102 comprises a crack line 202 that may be distinguished from the region surrounding the crack line by a machine. For example, the crack line 202 may be of white colour and the region surrounding the crack line may be of black colour thereby making the crack line 202 easily distinguishable from the region surrounding the crack line 202.

In an embodiment, the crack line 202 may comprise at least one colour. The colour may be uniformly distributed along the crack line 202 in a predefined disposition.

In an embodiment, the security label 102 may be monochromatic. For example, the security label 102 may be black and white in colour.

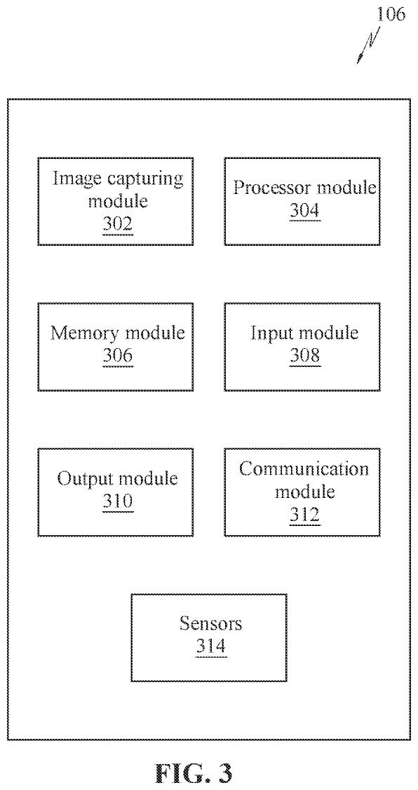

FIG. 3 illustrates the scanning device 106, in accordance with an embodiment. The scanning device 106 comprise an image capturing module 302, a processor module 304, a memory module 306, input modules 308, output modules 310, a communication module 312 and sensors 314.

The image capturing module 302 may be a camera that captures one or more images of the security label 102. The type of camera used may depend on the nature of the security label 102.

The processor module 304 may be implemented in the form of one or more processors and may be implemented as appropriate in hardware, computer-executable instructions, firmware, or combinations thereof. Computer-executable instruction or firmware implementations of the processor module 304 may include computer-executable or machine-executable instructions written in any suitable programming language to perform the various functions described.

The memory module 306 may include a permanent memory such as hard disk drive, may be configured to store data, and executable program instructions that are implemented by the processor module 304. The memory module 306 may be implemented in the form of a primary and a secondary memory. The memory module 306 may store additional data and program instructions that are loadable and executable on the processor module 304, as well as data generated during the execution of these programs. Further, the memory module 306 may be volatile memory, such as random-access memory and/or a disk drive, or non-volatile memory. The memory module 306 may comprise of removable memory such as a Compact Flash card, Memory Stick, Smart Media, Multimedia Card, Secure Digital memory, or any other memory storage that exists currently or may exist in the future.

The input modules 308 may provide an interface for input devices such as keypad, touch screen, mouse, microphone and stylus among other input devices.

The output modules 310 may provide an interface for output devices such as display screen, speakers, printer and haptic feedback devices, among other output devices.

The communication module 312 may be used by the scanning device 106 to communicate with the server 110. The communication module 312, as an example, may be a GPRS module, or other modules that enable communication. The communication module 312 may include a modem, a network interface card (such as Ethernet card), a communication port, or a Personal Computer Memory Card International Association (PCMCIA) slot, among others. The communication module 312 may include devices supporting both wired and wireless protocols. Data in the form of electronic, electromagnetic, optical, among other signals may be transferred via the communication module 312.

The sensors 314 may be used to determine the orientation of the scanning device 106. The sensors 314 may include, but not limited to, position sensor and gyro sensor.

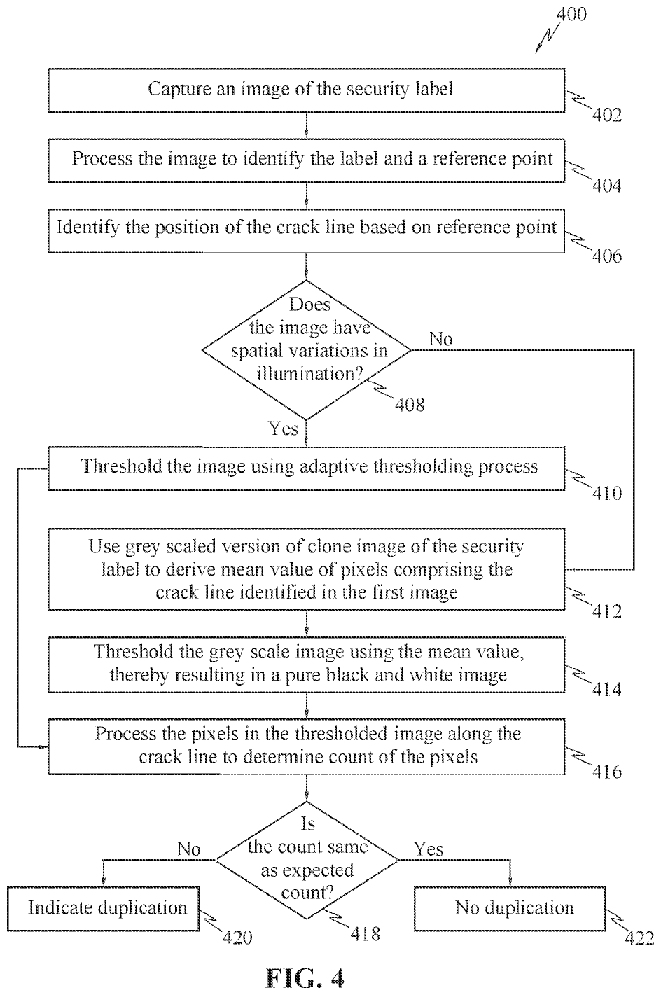

FIG. 4 is a flowchart 400 of method of determining duplicate security label. At step 402, an image of the security label 102 may be captured. The image capturing module 302 of the scanning device 106 may be used to capture the image of the security label 102. The image captured may be a coloured image or a black and white image. The scanning device may be positioned at a predetermined orientation to capture the image of the security label. The sensors of the scanning device may detect any change in the orientation of the scanning device. In some cases, the orientation of the security label may be changed instead of the scanning device. In such cases, the system may also be configured to detect and indicate any change in the orientation of the security label.

At step 404, the captured image may be processed to identify the label 102 and a reference point. For example, the reference point may be the geometric centre of the label 102. Before processing, firstly the image is equalized for any sort of localized glare thereby too much of glare is avoided. Glare can easily affect the result of the scanning process. At certain instances, light diffused layers can also affect the result in varying lighting condition. Secondly, processing needs to be done at subpixel accuracy. Important factors to be considered are device PPI (pixel per inch), display size and the DPI (dots per inch) of print-line. Therefore, depending on the device display size, image can be resized suitably. Further, height of scanning is another very important parameter that is determined depending on the device hardware. It shall be noted that, the quality of auto focus required to scan crack line is higher than quality required for normal QR code scan. Further, the scanning device may ask user to tilt the handset during scan as needed. The processor module 304 may traverse along a path to process the captured image and identify the label 102 and the reference point. The path traversed by the processor module 304 may comprise at least a portion of the crack line 202.

At step 406, the position of the crack line 202 in the captured image is identified based on the reference point. In one embodiment, the crack line 202 may be disposed on the label 102 at a certain predefined position from the reference point. This data pertaining to the disposition of the crack line 202 with respect to the reference point may be used to identify the location of the crack line 202.

In few cases, external edge of security labels can be considered as crack line to detect duplication by high resolution scanning device and high DPI printer. Crack line is made thin to take care of duplication-reproduction on higher DPI printer and original print is taken on lower DPI with non-ideal combination of ink/toner/substrate/printing-inconsistencies then crack-line can be damaged/smudged in original print. Under this situation, crack line is not essentially a fault-line within a portion of printed security label rather it can be the external edge of security label. Now given ideal match of substrate with toner/ink and smudge-free printing, even if the original print is scanned at high resolution scanning and then again print-reproduced at highest DPI printer provided consistent print-quality in long-haul, good focus and corrected image, it is still possible to detect duplicate version, provided iterating along the external-edge or internal-edge of fault-line is configured based on height of scanning, selection of right pixel as start point, resizing factor, thresholding parameters, number of pixels advanced in each step of iteration along the edge and shape of edge such as to capture sub-pixel level irregularities. This invention proposes circular shape of edge, (better choice compared to straight line edge) providing each two consecutive pixels diagonally connected along contour of edge and that relationship does not change with orientation of the scanning device with respect to label, given that image is perspective corrected before iterating along external edge, acting as crack line, to detect duplicate security label.

In order to detect duplicate security label, the region around the crack line 202 is considered as the region of interest. Firstly, the perspective of the acquired image is corrected. Further, if the captured image is a coloured image then the image is converted to a greyscale image and further region of interest around crack line is cropped, resized and thresholded.

At step 408, the captured image is analysed to determine whether the image has any spatial variations in illumination. It is well known that in a scenario, wherein the image has variations in illumination then adaptive thresholding is effective in thresholding the image. Therefore, if the captured image has variations in illumination, then at step 410, the captured image is thresholded using adaptive thresholding process. Further, the system proceeds to step 416, wherein the pixels in the thresholded image may be processed using the processor module 304 to determine the count of black and white pixels.

If the captured image does not have any spatial variations in illumination, then at step 412, the grey scaled version of the clone image may be used to derive mean values of pixels. In an embodiment, the captured image may be a coloured image, wherein the coloured image is first converted into a grey scale image using certain well-known techniques.

At step 414, the obtained mean values of the pixels may be used to threshold the grey scale image. For example, if the pixel values are within certain range it may be a crack line and if the pixel values are within certain range it may be the region surrounding the crack line. Therefore, the grey scale image may be converted into pure black and white image by thresholding the grey scale image using the mean values of the pixels. Such a technique may be referred as dynamic thresholding since the thresholding is based on the mean value specific to the pixels processed in a particular image.

At step 416, the pixels in the thresholded image may be processed using the processor module 304 to determine the count of black and white pixels. The processor module 304 may traverse along the path of the crack line 202 and may process the pixels along the path to determine the count of black and white pixels in thresholded image along the crack line.

At step 418, the actual count of black and white pixels may be compared with the expected count of the pixels. The expected count may be based on substrate, ink and printer DPI, which may be stored inside the scanning device 106 or may be predefined and stored in the server 110 of the system 100. The scanning device 106 may communicate with the server 110 to obtain the expected count and further may compare the actual count and the expected count of the pixels.

If the actual count of the pixels fails to concur with the expected count within a range, the system 100 may indicate duplication of the security label 102 at step 420. If the actual count of the pixels concurs with the expected count, the system 100 may indicate no duplication of the security label 102 at step 422.

The foregoing method may offer protection against the use of photocopied security label. The crack line 202 of the security label may be a thin and delicate line, of thickness less than 0.1 mm, such that it may be distorted in the photocopy of the security label. Therefore, the pixels of the region surrounding the crack line in the photocopy of the security label differ from pixels of the region surrounding the crack line in original security label. Hence, a difference in actual count of the pixels and expected count of the pixels is observed and the duplication is indicated. The thickness of the crack line may be configured as per original print-line DPI configuration. In an embodiment, multiple crack lines are provided on the security label.

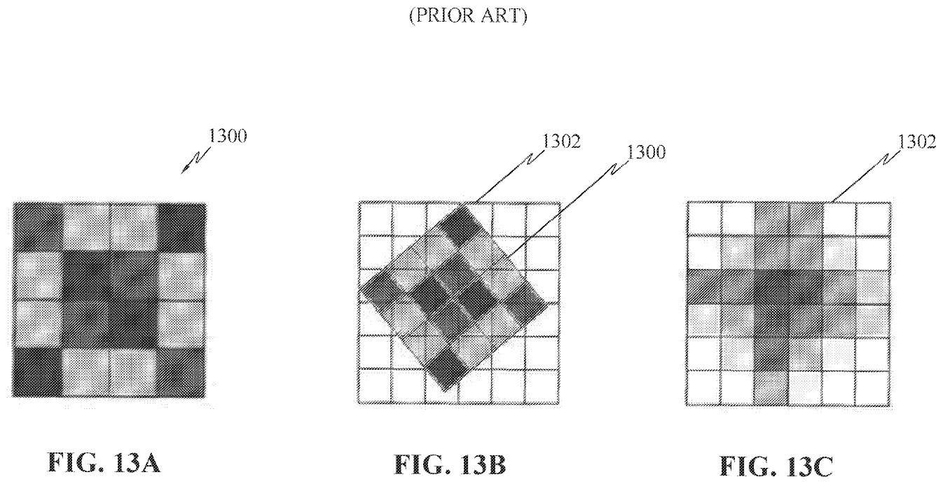

In one embodiment, the shape of the crack line 202 may define a symmetric path being agnostic to rotation of the scanning device 106. For example, the crack line 202 may be a circle around the centre of the security label 102, wherein even if the security label 102 is rotated the crack line appears as a circle when the scanning device 106 captures the image of the security label 102. Therefore, a user need not worry about how the label 102 is oriented relative to the scanning device 106. Additionally, the circular shape of the crack line does not affect the average count of the pixels because even if the orientation of scanning device relative to the label is changed the pixels-of-interest(s) still remain along the circular crack line. This particular advantage cannot be realized in a label 1300 having a non-circular crack line configuration as shown in FIGS. 13A, 13B and 13C.

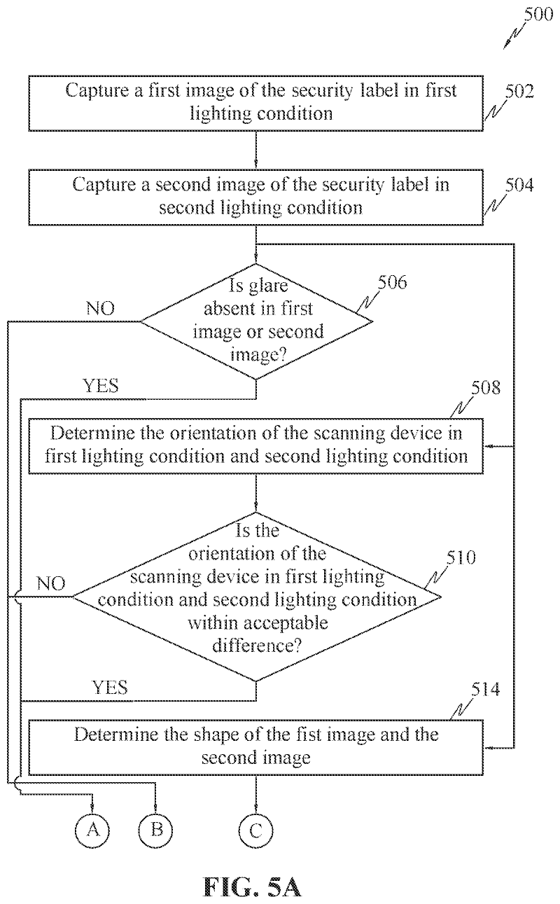

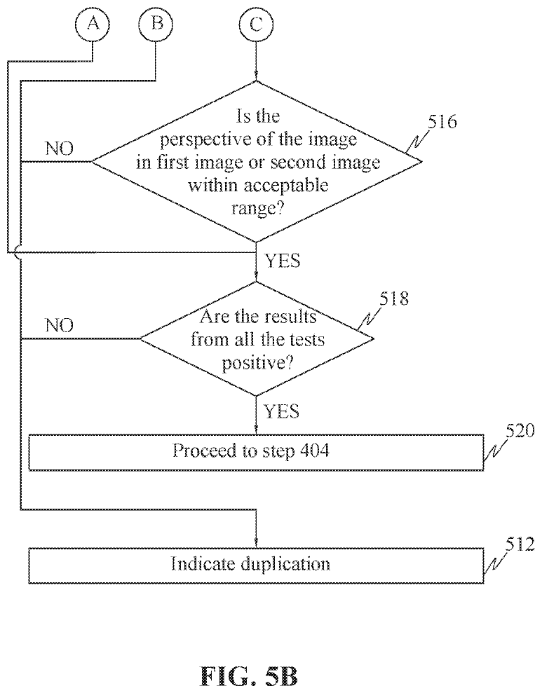

FIG. 5 is a flowchart 500 of method for detecting digital copy of the security label. A person with malicious intent may capture an image of the security label 102 in a digital device such as smart phone and may use the captured digital image to be scanned by the scanning device 106.

At step 502, the image capturing module 302 of the scanning device 106 may capture a first image of the security label 102 under a first lighting condition.

At step 504, the image capturing module 302 of the scanning device 106 may capture a second image of the security label 102 under a second lighting condition.

For example, the first lighting condition may be the condition wherein the flashlight is turned OFF and the second lighting condition may be the condition wherein the flashlight is turned ON. The transition between the lighting condition may be automatic, without requiring explicit input from the user.

At step 506, the first image and the second image may be inspected by the processor module 304 for any glare. If the image is a digital copy, then the flashlight may cause a reflection on the captured image thereby enabling the detection of digital copy of the security label. If at least one of the first image and second image comprises a glare, then at step 512, the system 100 may indicate duplication of the security label 102. If not, the system 100 may confirm authenticity of the security label 102 provided other tests are also positive.

At step 508, the orientation of the scanning device 106 in the first lighting condition and the second lighting condition may be determined. The sensors 314 may be used to determine the orientation of the scanning device 106.

At step 510, the orientation of the scanning device 106 in the first lighting condition and the second lighting condition may be compared to determine if they are within acceptable difference. This is done because, when a malevolent person tries to use a digital copy of the security label in a smart device to be scanned by the scanning device, the flashlight may cause a reflection on the capture image. So, the person may tend to change the orientation of the scanning device when the flashlight is turned ON such as to avoid glare in screen of smart device. Hence, the orientation of the scanning device in first lighting condition and second lighting condition is compared.

Secondly, the flashlight can be covered manually by a person with malicious intent to avoid glare or forcefully change the orientation of the scanning device due to glare. In order to detect such mal-intentioned action, scanning device also verifies the lighting profile of region of substrate where the security label is applied or printed, and if lighting/colour profile (as an example, hue, saturation, illumination) remains same across both flash ON and OFF condition, then an intrusion is detected.

Further, the malevolent person can also tilt the scanning device such as to avoid any glare on screen, however this can be addressed by enforcing the light OFF scan only when the scanning device is kept reasonably parallel and at centre over the screen such that when the flashlight is ON, instant glare is caused on the screen until user tilts the scanning device or tilts the security label and this behaviour is logged as anomaly. Further, one can still manage to position the scanning device over the screen reasonably parallel such that while hot spot is still on screen but slightly outside the image of label (i.e., region-of-interest on screen). Hot Spot is typically in form of concentrated brightest region. To handle this condition, it is proposed that the scanning device threshold the acquired image with suitable values that exposes the contoured region enclosing the hot spot. It shall be noted that the physical samples of region around the security label is coated with light-diffusing layer such that within that region on original label there cannot be any lighting hot spot. So, in acquired image if any hot spot is located within region that is configured to be light-diffused that it is indicated as duplicate. While this is good for detecting digital cloning it is also applicable for physical cloning without coating of light-diffused layer.

If the orientation of the scanning device 106 in the first lighting condition and the second lighting condition are not within acceptable range, the system 100 may indicate duplication at step 512.

In an embodiment, a range of permissible difference in the orientation of the scanning device 106 in the first lighting condition and the second lighting condition may be provided. The system 100 may indicate if the difference in the orientation of the scanning device 106 in the first lighting condition and the second lighting condition exceeds the predefined range.

If the orientation of the scanning device 106 in the first lighting condition and the second lighting condition is acceptable, then the system 100 may confirm authenticity of the security label 102 provided other tests are also positive.

At step 514, the shape of the first image and the second image may be determined. A malevolent person using digital copy for scanning may tilt the smart device comprising the digital copy of the security label to avoid reflection caused by the flashlight on the captured image.

At step 516, the perspective of the first image and the second image may be compared with each other. If the perspective of the first image or second image is not within acceptable shape, the system 100 may indicate duplication at step 512.

If the perspective of the first image and the second image is within acceptable shape, then at step 518, the system 100 may confirm authenticity of the security label 102 provided other tests are also positive.

At step 518, the system 100 may verify if outcome of all the tests are positive or not. If the outcome is positive, the system 100 may determine that the first image and the second image are not digital copy and further the system 100 may determine the authenticity of the security label 102, particularly with respect to crack line 202, as described in FIG. 4.

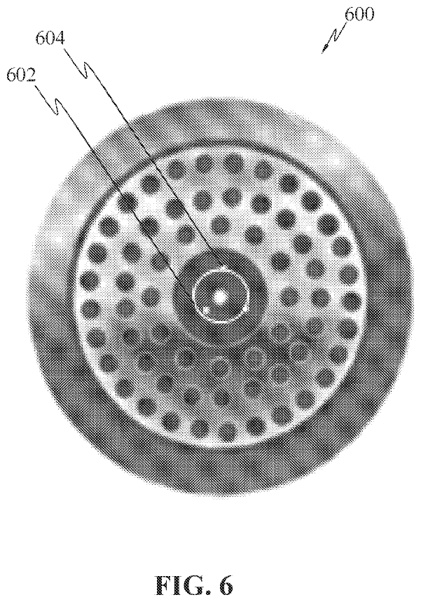

FIG. 6 illustrates a security label 600, in accordance with an embodiment. The security label 600 may comprise a crack line 602 that may further comprise a plurality of adjoining references 604. For example, the adjoining reference 604 may be a circular dot that may be disposed along the path of the crack line 602. The processor module 304 may be configured identify the adjoining references 604 and determine the position of the adjoining references 604 when processing the pixels to capture the crack line 602.

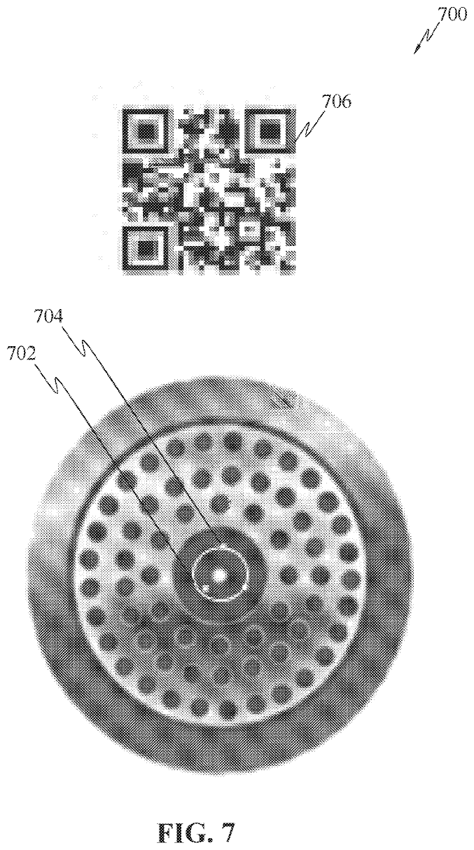

FIG. 7 illustrates a security label 700, in accordance with an embodiment. The security label 700 may comprise a crack line 702 that may further comprise a plurality of adjoining references 704. Further, the security label 700 may comprise a guide reference 706 that may be disposed external to the security label 700. The spatial orientation of at least two adjoining references 704 with respect to at least a portion of the guide reference 706 may be stored in the server 110. Further, the processor module 304 may be configured to determine the spatial orientation of at least two adjoining references 704 with respect to at least a portion of the guide reference 706 to authenticate the security label 700. As an example, the adjoining references 704 may be two circles that is located at certain angle and distance from a guide reference 706. The angle and distance data may be considered as the spatial orientation data. During verification process, when there is a difference between actual spatial orientation data and recorded spatial orientation data, the system 100 may indicate authenticity of the security label 700.

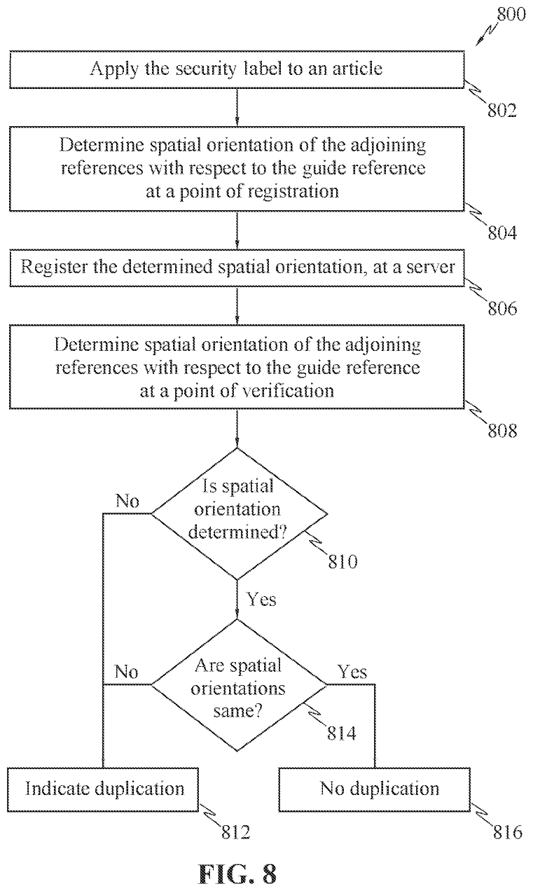

FIG. 8 is a flow chart 800 of method of authenticating the security label 700. At step 802, the security label 700 with a plurality of adjoining references 704 and a guide reference 706 may be applied to an article. Automatic application or manual application may be used to apply the security label 700 onto the article.

At step 804, at point of registration, the spatial orientation of the adjoining references 704 with respect to the guide reference 706 is determined. The scanning device 106 may capture at least an image of the security label 700 to determine the spatial orientation of the adjoining references 704 with respect to the guide reference 706.

At step 806, the determined spatial orientation of the adjoining references 704 with respect to the guide reference 706 for a given security label 700 is registered at the server 110.

At step 808, at point of verification, the spatial orientation of the adjoining references 704 with respect to the guide reference 706 is determined. Further, the scanning device 106 may capture at least an image of the security label 700 to determine the spatial orientation of the adjoining references 704 with respect to the guide reference 706.

At step 810, the scanning device 106 may determine the spatial orientation at the server 110. If the spatial orientation information is not determined at the server 110, the system 100 may indicate duplication of the security label 700 at step 812.

At step 814, the scanning device 106 may determine whether the spatial orientation at the point of verification is same as the spatial orientation at the point of registration. If they are same, then the system 100 may indicate no duplication of the security label 700 at step 816. If the spatial orientations are not same, the system 100 may indicate duplication of the security label 700 at step 812.

In an embodiment, the guide reference 706 may be a code that may be decipherable by a machine. As an example, the guide reference 706 may be a QR code, barcode and the like.

In an embodiment, the guide reference 706 may be a code that may be decipherable by human or machine. As an example, the guide reference 706 may be an alphanumeric code converted into an image. The orientation of alphanumeric code image with respect to the adjoining references may be considered as spatial orientation data.

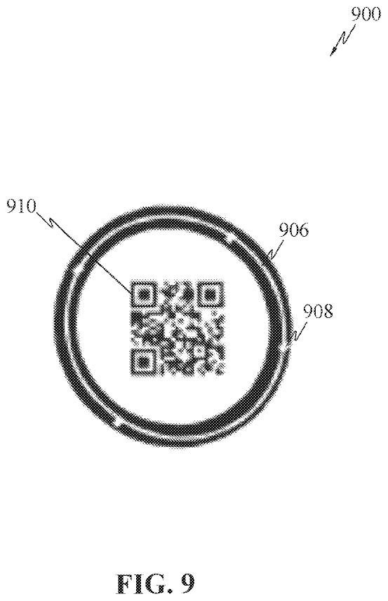

FIG. 9 illustrates a security label 900, in accordance with an embodiment. The security label 900 may comprise a crack line 902, a plurality of adjoining references 904 and a guide reference 906. The crack line 902 may define a boundary and the guide reference 906 may be present within the boundary. The spatial orientation between adjoining references 904 and at least a portion of the guide reference 906 may be used to determine authenticity of the security label 900.

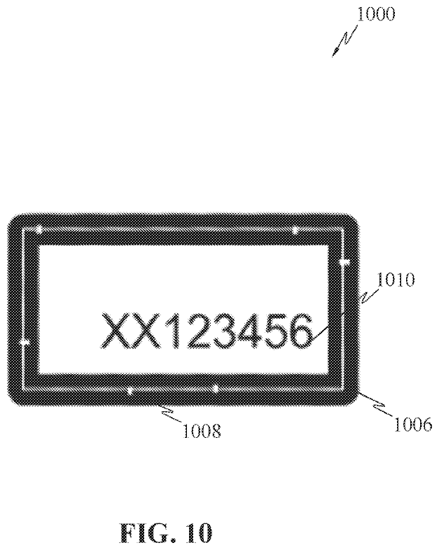

FIG. 10 illustrates a security label 1000, in accordance with an embodiment. The security label 1000 may comprise a crack line 1002, a plurality of adjoining references 1004 and an alphanumeric reference 1006. The alphanumeric reference 1006 may be enclosed within the crack line 1002 forming a boundary. Further, the spatial orientation of the alphanumeric reference 1006 may be used to determine authenticity of the security label 1000. The alphanumeric reference may be an ASCH code.

FIGS. 11A, 11B and 11C illustrates different orientations 1102, 1104 and 1106 of the alphanumeric reference 1006, in accordance with an embodiment. The alphanumeric reference may be used to determine the authenticity of the label. The parameters that may be used to determine the authenticity of the label may include but not limited to spatial positioning of the alphanumeric code, spacing between the characters of the code, linear arrangement of the characters, thickness of the outline.

As stated earlier, crack line may be configured in accordance to print-line DPI (dots per inch). It shall be noted that higher DPI print-line can be used to reproduce lower DPI crack line in such cases printing noise may be processed to detect duplicate security label Scanning device 106 is configured to determine varying PPI (pixel per inch) and accordingly the image is suitably processed to detect duplication of the security label. In security labels comprising more than one crack-line, wherein the thickness of the crack line is configured for different print-line DPI, if processing of one crack line does not yield conclusive results, either due to bad focus of scanning device or some dirt/dust/wrinkle, then another crack line can be processed to determine the authenticity of the security label.

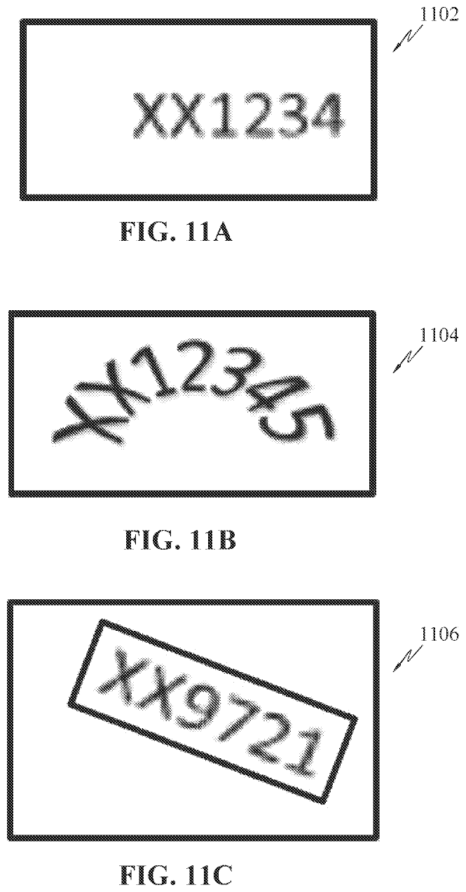

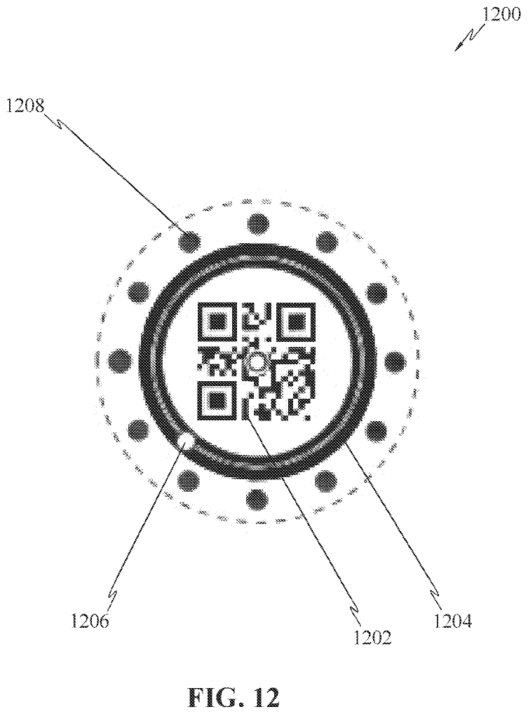

FIG. 12 illustrates a security label 1200, in accordance with an embodiment. The security label 1200 comprises a unique reference 1202, a crack line 1204, an adjoining reference 1206 disposed on the crack line 1204 and a pattern 1208. The unique reference 1202 may be QR code, bar code, alphanumeric code and the like, wherein the unique reference is unique to each security label. Further, the spatial orientation of the pattern 1208 may be associated with the unique reference 1202 of the label.

In an embodiment, the unique reference 1202 may be same for all the labels and the spatial orientation of the pattern 1208 may be different for each label. Referring to FIG. 12, an example of the spatial orientation is described. The pattern 1208 comprises twelve black dots that are disposed along the periphery of the label 1200. Further, the adjoining reference 1206 may be a white dot that is disposed along the crack line 1204 of the label 1200. The spatial disposition of the white dot relative to one or multiple black dots is considered as the spatial orientation of the label 1200.

It is to be noted that copy-proof labels are not protected from multiple parallel prints on original print-line if insiders connive together. This vulnerability can be handled easily. Spatial orientation of black dots (1208) with respect to white dot (1206) can be sequentially varied in artwork without printing any QR code at original print-line. At brand-owner print-line a serialized QR code is printed. Now the sequentially varied spatially oriented copy-proof print is associated with serialized QR code only at print-line of brand owner. So, if the brand owner does batch-registration of two labels in beginning, one label in middle and two labels in last of each batch, credentials of every labels can be automatically generated at backend without necessarily doing registration of every single label. Signatures for full batch can be generated because spatial orientation is sequentially varied and QR code is also serialized. Once it is desired to have randomized QR codes, serialized QR codes can be encrypted to make randomized or serialized value and can be appended with randomized string separated by delimiter. If full QR code string is randomized, then by encryption, the decryption key can be provisioned in registration APP and/or backend of the brand owner. Therefore, original print-line has no idea which QR code is associated with which spatial orientation and brand owner print-line just knows only about their QR codes and signatures are automatically generated at backend with no insider connivance and batch-registration mitigates operational overhead of individual piece registration.

As another example, the crack line may be discontinuous with many segments. Each of the segments may be at an angle relative to the centre of the label. This angular disposition of the segments of the crack line may be considered as spatial orientation data.

Another noteworthy point is that scanning the micro feature requires frame processing only when it is suitably focused by auto-focus of scanning device and to ensure frame is reasonably focused it is proposed to process frame for its micro feature only when the QR code in centre is read otherwise drop the frame and rescan. In another embodiment, QR code can be disposed exterior to the label.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1-30. (canceled)

31. A security label (1200) comprising:
at least one crack line (1204), wherein the thickness of the crack line (1204) is configured as per the resolution of printing or marking; and
at least a portion of the security label (1200), apart from an associated tracking code, is disposed as a variable image, wherein signature of the variable image portion in form of spatial orientation is linked with the associated tracking code;
wherein the crack line (1204) is configured to be line-scanned with sub-pixel processing and capturing of micro-variations generated when the security label (1200) is duplicated thereby determining the originality of the security label.

32. The security label (1200) as claimed in claim 31, wherein color of surrounding region along the crack line (1204) contrasts with respect to color of the crack line (1204).

33. The security label (1200) as claimed in claim 31, wherein shape of the crack line (1204) is symmetrical being agnostic to rotation of the label.

34. The security label (1200) as claimed in claim 31, wherein the crack line (1204) comprises at least one colour, wherein the colour is uniformly distributed along the crack line in a predefined disposition.

35. The security label (1200) as in claim 31, wherein the crack line (1204) is of a thickness, which is less than 0.1 mm.

36. The security label (1200) as in claim 31, wherein the crack line (1204) is a discontinuous line comprising multiple segments, wherein segments have varying angularly disposition with respect to a predefined point on the label (12).

37. The security label (1200) as in claim 31, wherein the spatial orientation of at least one of the adjoining references (1208) in relation to at least one guide reference (1206) and spatial orientation data is encoded in value of tracking code.

38. The security label as in claim 31, wherein the guide reference (706) is external to the security label (700) further comprises a plurality of adjoining references (704) connected to the crack line (702).

39. The security label as in claim 31, wherein the guide reference (706) is comprised in outline of the code associated with spatial orientation of the label and that is solely decipherable by a computing device.

40. The security label as in claim 31, wherein the guide reference (1010) is comprised within outline of tracking-code that is decipherable by a computing device and humans.

41. The security label as in claim 31, wherein the crack line (906) defines a boundary, wherein the guide reference (910) is within the boundary.

42. A method for determining authenticity of a security label, the method comprising:
capturing a first image of the security label under a first lighting condition;
capturing a second image of the security label under a second lighting condition;
identifying the presence and extent of glare by detecting lighting hotspot in acquired images;
and determining whether at least one of the first image and the second image is an image of a digital copy of the security label.

43. The method of claim 42, wherein determining whether image is the digital copy of the security label comprises detecting if change in lighting condition while scanning device orientation kept same as during previous lighting condition triggers the failure of label detection.

44. The method of claim 42, wherein determining whether any of the images is the image of the digital copy of the security label comprises identifying change in orientation, of a device capturing the images, between the first lighting condition and the second lighting condition, wherein illumination of the security label differs in the first and the second lighting conditions.

45. The method of claim 42, wherein determining whether any of the images is the image of the digital copy of the security label comprises identifying extent of perspective change of the security label in the images, wherein illumination of the security label differs in the first and the second lighting conditions.

46. A system for determining authenticity of security labels, the system comprising:
a security label comprising at least one crack line associated with spatially oriented portion and at-least one tracking code; and
a scanning device comprising an image capturing module and a processor module, wherein, the image capturing module is configured to acquire at least one image of the security label; and
the processor module is configured to:
process image to identify position of the crack line using the acquired image;
perform line-scan along the crack line and subpixel processing along crack-line by using the acquired image, to determine count of pixels in the processed image without human intervention, wherein the processed pixels are expected to constitute the path along the crack line; and
determine authenticity of the security label based on expected count and actual count of the processed pixels.

47. The system of claim 46, wherein the processor module is further configured to determine spatial orientation by computer vision of at least one adjoining reference among a plurality of adjoining references linked to the crack line in relation to at least one guide reference and spatial_orientation data along with unique value of the tracking code forms the 2-tuple credential.

48. The system of claim 46, wherein impression of crack-line & spatially oriented variable portion of security label is put on substrate in at-least one pass of manufacturing line;
Impression of the tracking code part of the security label is put on substrate in a pass on same or different manufacturing-line; and said tracking-code on given security label is interlinked with spatial orientation of variable portion on the same security label.

49. The system of claim 46, wherein a region around the security label is configured to be coated or laminated with light diffused layer such that to detect digital cloning any lighting hotspot within configured region with light diffused layer can be detected as an anomaly.
